(19) United States
(12) Patent Application Publication
(10) Pub. No.: US 2008/0135663 A1
(43) Pub. Date: Jun. 12, 2008

(54) TAPE LEADER BUCKLER HAVING INCREASED HOOKING AREA

(75) Inventors: Kevin S. Fletcher, Boulder, CO (US); Kristian S. Schartau, Bloomfield, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 11/923,501

(22) Filed: Oct. 24, 2007

Related U.S. Application Data
(60) Provisional application No. 60/856,502, filed on Nov. 3, 2006.

(51) Int. Cl. G11B 15/66

(52) U.S. Cl. 242/332.4

(57) ABSTRACT

In one example, a tape drive system including a buckler system having a hook member is provided. The tape drive system includes a take-up leader and a buckler, the buckler for selectively retaining the drive leader, the buckler comprising a hook member for extending through an aperture of the take-up leader, the aperture having an area substantially equal to a cross-sectional area of a proximate portion of the hook member. In another example, a length of a proximate portion of the hook member along a longitudinal direction of the take-up leader is substantially equal to the longitudinal length of the aperture in the take-up leader.

### RELATED APPLICATION

This application claims the benefit of U.S. Provisional Patent Application Ser. No. 60/856,502, entitled “TAPE LEADER BUCKLER HAVING INCREASED HOOKING AREA,” and filed Nov. 3, 2006, which is hereby incorporated by reference in its entirety for all purposes.

### BACKGROUND

1. Field

The present invention relates generally to buckler mechanisms and systems for use with tape drives that utilize a cartridge containing a storage tape for storing data. More specifically, the present invention relates to a tape drive having a buckler for buckling and unbuckling a cartridge leader on the storage tape to a drive leader of the tape drive.

2. Related Art

Digital data is stored on tape drives utilizing a variety of designs, but in all cases, magnetic tape media is wound between a pair of tape reels as data is transferred to or from the tape media. In the art of data storage, the physical space required to store data is an important concern. To conserve space, tape drives often use a single reel tape cartridge design, which utilizes a supply reel located within a removable tape cartridge and a take-up reel located within the tape drive.

After the tape cartridge is inserted into the tape drive, the tape media must be loaded into the tape drive. The loading operation includes connecting the tape media to the take-up reel and winding the tape media to a start point or read position. Various systems and methods have been employed to make this connection. FIG. 5 illustrates one such system and method where the tape media connects to the take-up reel via a buckle 100 between a tape cartridge leader 103 and a take-up leader 101. The tape cartridge leader 103 terminates the tape media at one end and is a strong flexible plastic strip that includes an ovular aperture 102 configured to mate with the take-up leader 101. The take-up leader 101 is a similar strong flexible plastic strip attached at one end to the take-up reel. The opposing end includes a stem 104 and a tab 105 designed to buckle with the ovular aperture 102 on the tape cartridge leader 103.

During the buckling operation, a rotating catch or hook of a buckler mechanism connected to a load motor cooperates with a positioning lever to position the take-up leader 101 and the tape cartridge leader 103 for buckling. For example, a catch of the buckler may rotate through aperture 106 to catch and direct take-up leader 101. After the take-up leader 101 and the tape cartridge leader 103 are buckled, the catch is rotated out of the way of take-up leader 101 and aperture 106 to a loaded position and the buckle 100 is wound through a tape path until the tape media is in a read position relative to the tape head. Similarly, an unloading operation includes unwinding the take-up leader 101 and tape cartridge leader 103 back past the tape head, rotating the catch back to the unloaded position to disconnect the take-up leader 101 and the tape cartridge leader 103, and ejecting the tape cartridge from the tape drive.

Such a buckler system is described, for example, in U.S. Pat. Nos. 6,095,445 and 6,614,611, both of which are incorporated herein by reference in their entirety.

### BRIEF SUMMARY

In one aspect of the present invention a buckler for engaging a drive take-up leader is provided. In one example, the buckler includes a hook member, wherein a proximate portion of the hook member has a longitudinal length substantially equal to a longitudinal length of an aperture of a drive take-up leader. In another example, a buckler is provided having a hook member, wherein a proximate portion of the hook member has a cross-sectional area substantially equal to the area of an aperture of the drive take-up leader.

In one example, the hook member is sized to engage opposing edges of the aperture of the take-up leader (e.g., along a longitudinal direction). Further, the buckler or hook member may include a second hook on an opposite side of a first or primary hook along a longitudinal direction for engaging opposing edges of the aperture of the drive take-up leader.

In another aspect of the present invention a storage media drive system is provided (e.g., a magnetic or optical tape drive). In one example, the system includes a take-up leader having an aperture therein, and a buckler for selectively retaining the drive leader, the buckler comprising a hook member for extending through the aperture of the take-up leader, the aperture having an area substantially equal to a cross-sectional area of a proximate portion of the hook member.

In another example, the system includes a take-up leader having an aperture therein, and a buckler for selectively retaining the drive leader, the buckler comprising a hook member for extending through the aperture of the take-up leader, wherein a length of a proximate portion of the hook member along a longitudinal direction of the take-up leader is substantially equal to the longitudinal length of the aperture in the take-up leader.

The present invention and its various embodiments are better understood upon consideration of the detailed description below in conjunction with the accompanying drawings and claims.

### BRIEF DESCRIPTION OF THE DRAWINGS

FIG. 1 illustrates an exemplary tape drive system having a tape leader buckler according to one example of the present invention;

FIG. 2 illustrates a buckler system;

FIG. 3 illustrates a buckler system according to one example of the present invention;

FIGS. 4A-4F illustrate various perspective, front, and side views of the exemplary buckler system interacting with a drive leader according to one example;

FIG. 5 illustrates an exemplary buckling system and method for connecting a take-up leader and a cartridge leader; and

FIG. 6 illustrates an exemplary magnetic storage library including an exemplary tape drive system described herein.

### DETAILED DESCRIPTION

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

In one example herein, a buckler is provided having an increased hooking area relative to prior art bucklers (for similarly configured drive leaders etc.). The additional area added to the hooking area may reduce the potential for the drive leader to disengage or slip off when the take-up leader and buckler are in a cartridge not present situation, e.g., when the tape drive receiver is empty. For instance, the increased area of the hooking area relative to the aperture may provide a tighter, more secure fit of the hooking member within the aperture of the drive leader, thereby reducing slack in the drive leader such that vibrations or shock events are less likely to cause the drive leader to disengage or slip off of the buckler, which may cause errors in the drive operation or damage to the drive and/or the cartridge. Accordingly, in one example described herein, the proximate end of the hook member (e.g., the cross-sectional area as it extends from the buckler, or its length along the longitudinal direction of the take-up leader) is approximately the same size (either area or length) as an aperture of the take-up leader to create a friction fit.

When the cartridge is loading, the exemplary buckler performs similarly to prior art buckles, rotating out of the way and allowing the tape leader to slide off of the buckle hook when the buckler is rotated to the normal cartridge loaded position. Additionally, the shape and curvature of the hook may be such that the drive leader and tape path are substantially unchanged during operation of the buckler.

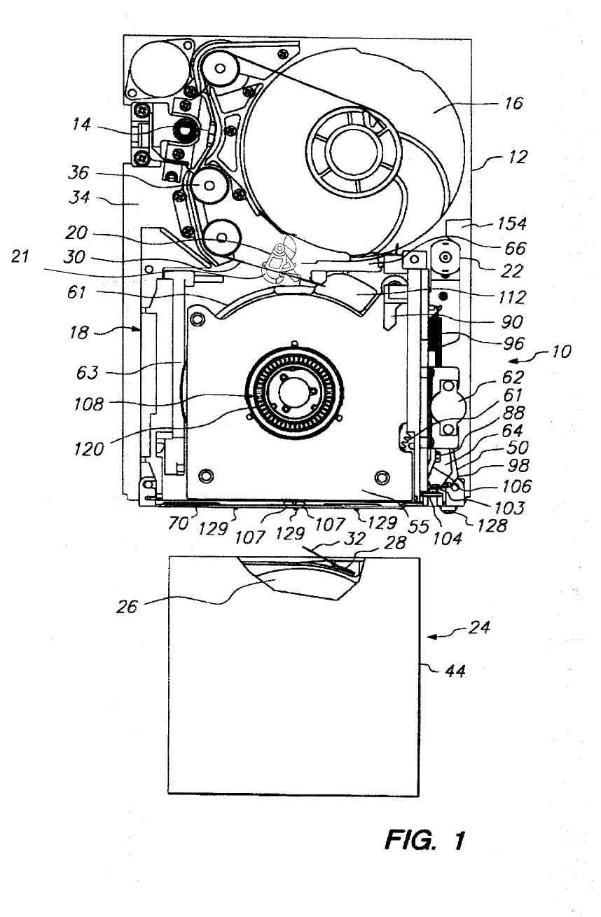

With reference initially to FIG. 1, a tape drive 10 having features of the present invention includes a drive housing 12, a data transducer 14, a take-up reel 16, a receiver 18, a buckler 20, and a buckler motor 22. The tape drive 10 is used in conjunction with a cartridge 24 having a cartridge reel 26 which contains a storage tape 28. As recognized in the art, the buckler motor 22 selectively moves the buckler 20 relative to the receiver 18 to automatically couple and uncouple a drive leader 30 attached to the take-up reel 16 to a cartridge leader 32 attached to the storage tape 28. As described in greater detail below, and in one example of the present invention, buckler 20 further includes a hook 21 (sometimes referred to as a catch) having a proximate portion sized approximately to fit within an aperture of take-up leader 30 and provide greater support of take-up leader 30 in an unloaded state.

A detailed description of the various components of a tape drive 10 may also be found in U.S. Pat. Nos. 6,614,611, 6,095,445, and 5,371,638, all of which are assigned to Quantum Corporation, the Assignee of the present invention, and further, all of which are hereby incorporated by reference as if fully set forth herein. Further, a representative tape drive 10 is sold by Quantum Corporation, the Assignee of the present invention under the trademark VS-160, DLT-V4.

Drive housing 12 retains the various components of the tape drive 10. The drive housing 12, shown in FIG. 1, includes a base 34 which retains the various components of the tape drive 10. The drive housing 12 also includes side walls, a back, and a top which are not shown in FIG. 1 for clarity. The tape drive 10 includes a plurality of tape rollers 36 for guiding the storage tape 28 past the data transducer 14 and onto the take-up reel 16.

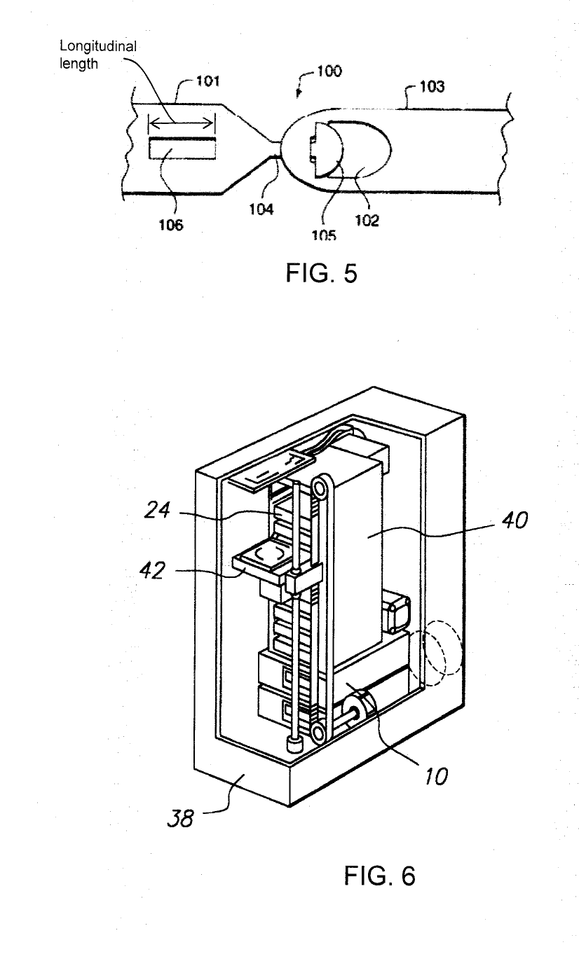

Tape drive 10 is typically installed within a computer (not shown), or an external enclosure (not shown). Alternately, the tape drive 10 can be utilized as part of a tape library 38, as illustrated in FIG. 6. Tape library 38 includes a plurality of cartridges 24 which are retained in a multiple cartridge magazine 40, a robotic cartridge handler 42 and one or more tape drives 10. The robotic cartridge handler 42 is used to selectively retrieve one of the cartridges 24 from the cartridge magazine 40 and place the cartridge 24 within one of the tape drives 10. A suitable tape library 38 is sold under the trademark DLTstor™, by Quantum Corporation.

Storage tape 28 stores data in a form that can be subsequently retrieved if necessary, e.g., magnetically optically stored in digital form. In one example, storage tape 28 has a tape width of approximately one-half an inch (0.5 in) in width. Alternatively, for example, the storage tape 28 can have a tape width of between approximately four millimeters to eight millimeters (4.0 mm-8.0 mm).

The storage tape 28 illustrated in the Figures may include a storage surface on one side of the storage tape 28 for storing data. The storage surface is divided into a plurality of tracks (not shown). Each track can be a linear pattern which extends the length of the storage tape 28. Alternately, for example, the data can be recorded in diagonal strips across the storage tape 28. As provided herein, the storage tape 28 can have between approximately one hundred and twenty-eight to two hundred and eight (128-208) tracks per tape 28. The storage tape 28 is initially retained on the cartridge reel 26 of the cartridge 24. Referring back to FIG. 1, the cartridge 24 includes a substantially rectangular cartridge housing 44 which encloses the cartridge reel 26 and the storage tape 28. A suitable cartridge 24 is sold by Quantum Corporation under the Trademark DLTtape™ IV.

The buckler motor 22, a gear train 60, the interposer 50, a damper 62, and a write protect lever 64 may be positioned proximate to the right receiver side wall 54, while a load ring 61 and a clutch link 63 are positioned below the receiver bottom 55. An eject carriage mechanism 58 is attached to and slides relative to the right receiver side wall 54. The buckler 20 and a mushroom cam 66 are positioned near a receiver back 68 of the receiver 18 while a flex circuit 70 is secured to a receiver front 72 of the receiver 18. The load ring 61, the buckler 20, and a mushroom cam 66 each rotate relative to the receiver slot 49.

The design of the buckler motor 22 can be varied. For example, the buckler motor 22, illustrated in the Figures, is a small electric motor mounted to the drive housing 12. In order to precisely move the buckler 20, the buckler motor 22 is linked to the load ring 61 with the gear train 60 to gear down the rotation of the load ring 61 and the buckler 20. Basically, the gear train 60 includes a plurality of gears which reduce the rotation of the load ring 61 relative to rotation of the buckler motor 22. Thus, a relatively large amount of rotation of the buckler motor 22 is reduced with the gear train 60 into a relatively small amount of rotation of the load ring 61. In the example illustrated in the Figures, the gear train 60 has a gear ratio of approximately 1430:1. This ratio allows for the very precise rotation of the load ring 61 and the buckler 20 relative to the receiver 18.

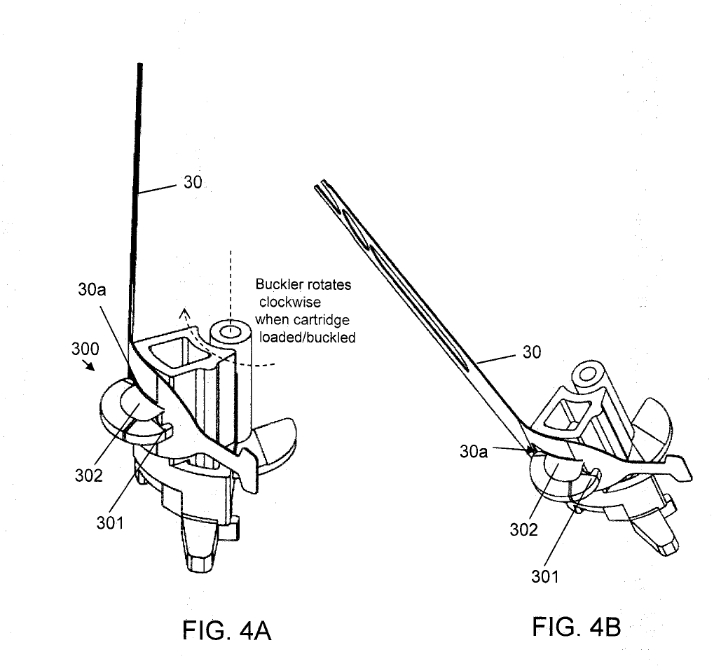

The buckler 20 rotates relative to the receiver 18 on a buckler pin between a coupled position and an uncoupled position. A spring biases the buckler 20 to return to the uncoupled position. Buckler 20 may includes a front surface and a hook 21 which projects away from the front surface (see FIG. 3 for a more detailed view of buckler 20). The hook 21 is positionable within an aperture of the drive leader 30 to selectively retain the drive leader 30.

The tape drive 10 further includes a controller 154 operable to activate the buckler motor 22 after the cartridge 24 has been inserted into the receiver 18. The controller includes or accesses hardware, software, and/or firmware operable for controlling and monitoring the status the tape drive 10 and can be implemented in a number of alternate ways. The controller 154 is represented as a block in FIG. 1 for illustration purposes only. Those skilled in the art will recognize that the design and location of the controller 154 can be varied. The controller 154 can be electrically connected to the motor 22, the flex circuit 70, and other electrical devices and switches of tape drive 10.

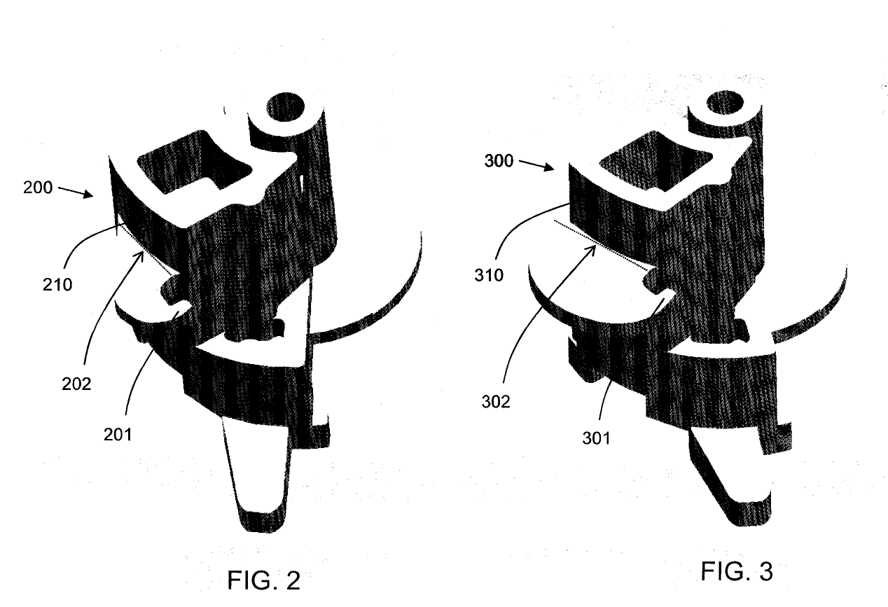

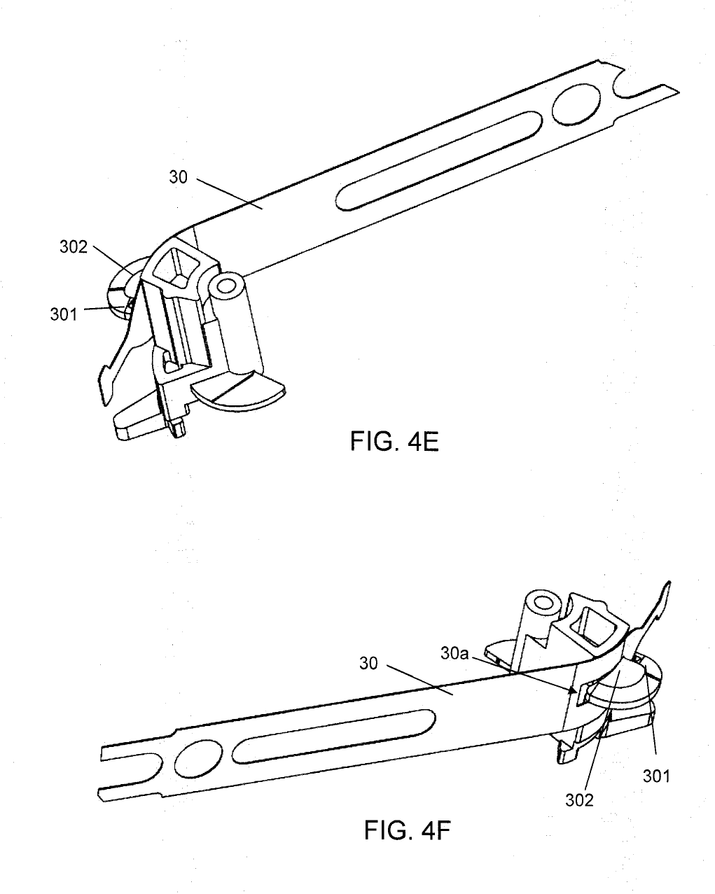

FIGS. 2 and 3 illustrate exemplary buckler systems. With reference to FIG. 2, buckler 200 is illustrated and includes a catch or hook 201 extending away from a front surface 210 of buckler 200 (e.g., a surface that opposes and may support the drive take-up leader during operation). The proximate portion 202 of hook 201 is sized substantially smaller than the aperture (e.g., illustrated in FIG. 5) of the take-up leader. For example, the cross-sectional area of the proximate portion 202 as it extends from surface 210 is typically less than 50% of the area of the aperture of the take-up leader. Alternatively, the length of the proximate portion 202 along a longitudinal direction of the take-up leader (e.g., horizontally along surface 210) is typically substantially less than of the length of the aperture in the take-up leader. Accordingly, when the hook is in an unloaded position, and inserted through the aperture of the drive take-up leader the proximate end 202 of hook 201 typically only engages one edge of the aperture. Thus, during vibration or shock, tension may be lost and the take-up leader may slip or fall off the hook 201.

In comparison to buckler 200, buckler 300 comprises a hook portion 301, wherein the proximate portion 302 of hook 301, extending away from surface 310, is relatively larger (than the proximate portion 202 of buckler 200) and sized according to the aperture of the drive take-up leader. For example, the cross-sectional area of the proximate portion 302 of hook 301 extending away from the surface 310 is substantially the same size as an aperture of the drive take-up leader to provide a relatively closer fit with the take-up leader. In another example, the proximate portion of hook portion 302 may include a longitudinal length (e.g., along the direction of the path of the take-up leader, or along the rotational direction of the buckler) that is approximately equal to the longitudinal length of the aperture of the take-up leader.

In one example, the cross-sectional area or the longitudinal length of the proximate end 302 of hook 301 may be greater than 50% of the aperture area or length respectively. In one example, the area or length of the proximate end 302 and aperture are substantially equal, e.g., within 20% of each other, in another example within 10% of each other, in another example within 5% of each other, in another example within 1% of each other, and in another example they are equal.

The substantially equal size (e.g., area or length) of the proximate portion 302 of hook 301 relative to the aperture provides support at opposing inner edges of the aperture in the drive take-up leader in the unloaded position. Thus, in one example, the proximate portion 302 of hook 301 provides a more secure fit within the aperture and reduces the chances that the drive take-up leader may slip or fall off the buckler in response to vibration or shock events. For example, during shipping or movement of a drive, when the buckler is in the unloaded position, the increased size of the proximate portion 302 may provide increased support of the drive take-up leader to vibrations or shock events.

It should be noted that the proximate portion 302 could be formed in other manners, e.g., including two or more projections extending from surface 310 and supporting hook 301, such that the longitudinal length (or area of the perimeter) of the entire structure is approximately the same as the aperture.

In other examples, the proximal end of the hook portion could be wedged (e.g., wider toward the rotational axis of the buckler and narrowed as it extends from the rotation axis) such that the hook portion extends through the aperture of the take-up to create a loose interference fit with the aperture along the longitudinal direction, the vertical direction, or both. In such an example, the interference fit is sufficiently slight that upon rotation of buckler 300 hook 301 releases the drive take-up leader.

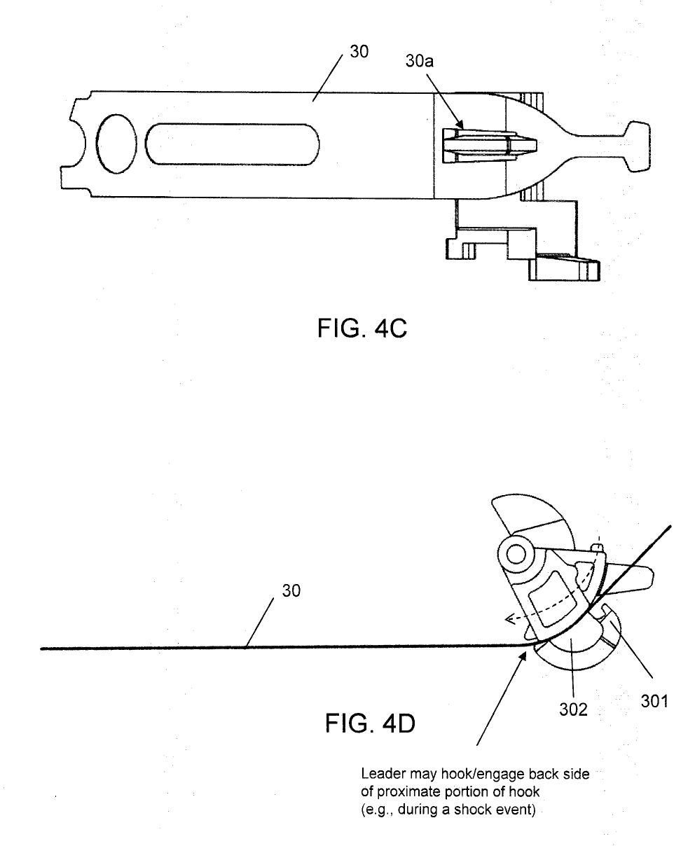

FIGS. 4A-4F illustrate various perspective, front, and side views of the exemplary buckler 300 interacting with a drive take-up leader 330 in greater detail. Additionally, FIGS. 4A-4F illustrate the close fit of aperture 30a with the proximate portion of the buckler hook.

The Figures generally show the buckler 300 and drive take-up leader 330 in a cartridge not present situation, with hook 301 fully inserted into aperture 30a of drive take-up leader 30. When a cartridge is loaded and buckled, buckler 300 operates to rotate clockwise as seen in FIG. 4A to release take-up leader 30 and move out of the way for tape to be streamed through the media drive and onto the take-up reel.

As clearly shown, the proximate portion 302 of hook 301 has a cross-sectional area and longitudinal length substantially equal to the area and length respectively of aperture 30a, thereby creating a more secure fit with drive take-up leader 30 in the unloaded, cartridge not present position (as shown).

In some examples, hook 301 may be shaped to form a second hook or catch on the back side (e.g., opposite longitudinally from hook 301), the second hook operable to hook an edge of the aperture 30a of drive take-up leader 30 as illustrated in FIG. 4D. For example, leader 30 may hook or engage the back side of aperture 30a to secure take-up leader 30 during a shock event or vibration; in other examples, such a result may occur during normal operation in a cartridge not present position.

Additionally, as seen in the side-view of FIG. 4C, hook 301 and/or aperture 30a may be tapered; for example, narrowing from left to right as illustrated. Such a taper may allow hook 301 to more smoothly “hook” aperture 30a and self adjust or self align, correcting for height mismatches during operation.

The above detailed description is provided to illustrate exemplary embodiments and is not intended to be limiting. It will be apparent to those skilled in the art that numerous modifications and variations within the scope of the present invention are possible. For example, various other shapes or profiles of a hooking member may be implemented that includes features in addition to those described. Moreover, throughout the description, particular examples have been discussed and how these examples are thought to address certain disadvantages in related art. This discussion is not meant, however, to restrict the various examples to methods and/or systems that actually address or solve the disadvantages. Accordingly, the present invention is defined by the appended claims and should not be limited by the description herein.

1. A storage medium drive system, comprising:
a take-up leader having an aperture therein; and
a buckler for selectively retaining the drive leader, the buckler comprising a hook member for extending through the aperture of the take-up leader, the aperture having an area substantially equal to a cross-sectional area of a proximate portion of the hook member.

2. The system of claim 1, wherein the hook member creates an interference fit with at least a portion of the aperture when extended therethrough.

3. The system of claim 1, wherein the hook member engages opposing sides of the aperture when extended therethrough.

4. The system of claim 1, wherein the hook member comprises a first hook member and a second hook member for hooking opposite sides of the aperture.

5. The system of claim 1, wherein the hook member is wedged.

6. The system of claim 1, wherein a length of the proximate portion of the hook member is within 10% of a length of the aperture along a direction of transport.

7. The system of claim 1, wherein a length of the proximate portion of the hook member extending within an aperture is equal to the length of the aperture along a direction of transport.

8. The system of claim 1, wherein the cross-sectional area of the proximate portion of the hook member along the direction of extension is within 10% of the area of the aperture.

9. The system of claim 1, wherein the hook member rotates to selectively retain the drive leader.

10. A storage medium drive system, comprising:
a take-up leader having an aperture therein; and
a buckler for selectively retaining the drive leader, the buckler comprising a hook member for extending through the aperture of the take-up leader, wherein a length of a proximate portion of the hook member along a longitudinal direction of the take-up leader is substantially equal to the longitudinal length of the aperture in the take-up leader.

11. The system of claim 10, wherein the hook member creates an interference fit with at least a portion of the aperture when extended therethrough.

12. The system of claim 10, wherein the hook member engages opposing sides of the aperture when extended therethrough.

13. The system of claim 10, wherein the hook member comprises a first hook member and a second hook member for hooking opposite sides of the aperture.

14. The system of claim 10, wherein the hook member is wedged.

15. The system of claim 10, wherein the length of the proximate portion of the hook member is within 10% of the length of the aperture along a direction of transport.

16. The system of claim 10, wherein the hook member rotates to selectively retain the drive leader.

17. A buckler comprising:
a hook member for insertion within an aperture of a drive take-up leader, the hook member having a distal hook portion and a proximate portion, the proximate portion having a length transverse to the direction the hook member extends greater than a length of the distal hook portion.

18. The buckler of claim 17, wherein the hook member comprises a first hook member and a second hook member for hooking opposite sides of the aperture.

19. The buckler of claim 17, wherein the hook member comprises a first hook member and a second hook member oriented in opposite directions.

20. The buckler of claim 17, wherein the proximate portion includes a longitudinal length substantially equal to the aperture.

21. The buckler of claim 17, wherein the proximate portion includes a cross-sectional area extending from a surface of the buckler, the cross-sectional area substantially equal to the aperture.
